(19) United States
(12) Patent Application Publication
(10) Pub. No.: US 2025/0214388 A1
(43) Pub. Date: Jul. 3, 2025

(54) DRIVING ROBOT WITH SUSPENSION STRUCTURE

(71) Applicant: SAMSUNG ELECTRONICS CO., LTD., Suwon-si (KR)

(72) Inventors: Seungbi Lee, Suwon-si (KR); Wanku Kang, Suwon-si (KR); Sangyul Yang, Suwon-si (KR); Jaehyun Park, Suwon-si (KR)

(73) Assignee: SAMSUNG ELECTRONICS CO., LTD., Suwon-si (KR)

(21) Appl. No.: 19/008,337

(22) Filed: Jan. 2, 2025

Related U.S. Application Data
(63) Continuation of application No. PCT/KR2024/019863, filed on Dec. 5, 2024.

(30) Foreign Application Priority Data
Jan. 3, 2024 (KR) 10-2024-0001054

(51) Int. Cl. B60G 17/056; B25J 5/00

(52) U.S. Cl. CPC B60G 17/0565; B25J 5/007; B60G 2202/152; B60G 2300/40

(57) ABSTRACT

A driving robot may be provided and include: a base; a first driving wheel on a left side of the base; a second driving wheel on a right side of the base; and a plurality of caster units at a front and rear of the first driving wheel and a front and rear of the second driving wheel, respectively. Each of the plurality of caster units may include: a caster; and an air suspension configured to dampen the caster so as to be liftable by pneumatic pressure, and wherein the air suspension of a first caster unit among the plurality of caster units is connected to the air suspension of a second caster unit among the plurality of caster units by a single flow path.

### CROSS-REFERENCE TO RELATED APPLICATIONS

This application is a bypass continuation of International Application No. PCT/KR2024/019863, filed on Dec. 5, 2024, in the Korean Intellectual Property Receiving Office, which claims priority to Korean Patent Application No. 10-2024-0001054, filed on Jan. 3, 2024, in the Korean Intellectual Property Office, the disclosures of each of which are incorporated by reference herein in their entireties.

### BACKGROUND

### 1. Field

Embodiments of the present disclosure relate to a driving robot that can improve driving stability by quickly reducing vibration of the driving robot with optimized damping performance according to a driving environment.

### 2. Brief Description of Background Art

When a driving robot travels on an uneven running surface, the force applied to a plurality of casters arranged around a driving wheel of the driving robot may vary. When the running surface in contact with each caster is tilted or has a step, the driving robot may tilt left and right or forward and backward, and the vertical force applied to each caster may not be constant. In this case, at least one of the plurality of casters may be spaced apart from the running surface and may float in the air, resulting in an afloat time. Accordingly, the posture of the driving robot may become unstable and significantly shaky, causing a problem of making the driving robot change its driving direction or stop.

### SUMMARY

According to an embodiment of the present discourse, a driving robot may be provided and include: a base; a first driving wheel on a left side of the base; a second driving wheel on a right side of the base; and a plurality of caster units at a front and rear of the first driving wheel and a front and rear of the second driving wheel, respectively. Each of the plurality of caster units may include: a caster; and an air suspension configured to dampen the caster so as to be liftable by pneumatic pressure, and wherein the air suspension of a first caster unit among the plurality of caster units is connected to the air suspension of a second caster unit among the plurality of caster units by a single flow path.

According to an embodiments of the present disclosure, an inside of the air suspension of the first caster unit and an inside of the air suspension of the second caster unit may be communicated through an air tube.

According to an embodiments of the present disclosure, the air suspension may include: a housing including a surge chamber; and an orifice member configured to adjust an amount of air entering and exiting the surge chamber of the housing.

According to an embodiments of the present disclosure, the air suspension may include a fastening hole on an upper portion of the housing, to which the orifice member is detachably coupled.

According to an embodiments of the present disclosure, the fastening hole of the housing may include a first thread portion on an inner circumferential surface of the housing; and wherein the orifice member may include a second thread portion on an outer circumferential surface of the orifice member, which is screwed to the first thread portion.

According to an embodiments of the present disclosure, the orifice member may be a full threaded bolt.

According to an embodiments of the present disclosure, the orifice member may include: a first hole at a first end of the orifice member; a second hole at a second end of the orifice member, opposite of the first end of the orifice member, the second hole communicated with the first hole; and an air passage hole between the first hole and the second hole and smaller than the first hole and the second hole.

According to an embodiments of the present disclosure, the air suspension may include: a shaft, wherein a first end of the shaft is connected to the caster and a second end of the shaft, opposite to the first end of the shaft, is inside the housing; a linear bush coupled to an inside of the housing and slidably supporting an outer circumference of the shaft; and an elastic member in the surge chamber of the housing and elastically supporting the shaft along an axial direction of the housing.

According to an embodiments of the present disclosure, the driving robot may further include: at least one additional orifice member that is screwed to the housing, the at least one additional orifice member configured to adjust the amount of air entering and exiting the surge chamber of the housing.

According to an embodiments of the present disclosure, the orifice member may be screwed to an upper surface of the housing or a side surface of the housing.

According to an embodiments of the present disclosure, an upper end of the housing may be open; and wherein the orifice member may be coupled to the housing, and configured to open and close the upper end of the housing.

According to an embodiments of the present disclosure, the plurality of caster units may include: the first caster unit, wherein the air suspension of the first caster unit is a first air suspension that is in front of the first driving wheel; the second caster unit, wherein the air suspension of the second caster unit is a second air suspension that is in front of the second driving wheel; a third caster unit, wherein the air suspension of the third caster unit is a third air suspension that is behind the first driving wheel; and a fourth caster unit, wherein the air suspension of the fourth caster unit is a fourth air suspension that is behind the second driving wheel, wherein the first air suspension and the third air suspension are communicated through a first air tube; and wherein the second air suspension and the fourth air suspension are communicated through a second air tube.

According to an embodiments of the present disclosure, the driving robot may further include a third air tube interconnecting the first air tube and the second air tube.

According to an embodiments of the present disclosure, each of the first air suspension, the second air suspension, the third air suspension, and the fourth air suspension may include: a housing including a surge chamber; and a first orifice member configured to adjust an amount of air entering and exiting the surge chamber of the housing.

According to an embodiments of the present disclosure, the driving robot may further include: a fifth air suspension configured to dampen the first driving wheel, and connected to the first air tube such as to communicate with the first air suspension and the third air suspension; and a sixth air suspension configured to dampen the second driving wheel, and connected to the second air tube such as to communicate with the second air suspension and the fourth air suspension.

According to embodiments of the present disclosure, a driving robot may be provided and include: a base; a first driving wheel on a left side of the base; a second driving wheel on a right side of the base; a first caster at a front of the first driving wheel; a second caster at a front of the second driving wheel; a third caster at a rear of the first driving wheel; a fourth caster at a rear of the second driving wheel; a first air suspension configured to dampen the first caster; a second air suspension configured to dampen the second caster; a third air suspension configured to dampen the third caster; a fourth air suspension configured to dampen the fourth caster; a first air tube connecting the first air suspension and the third air suspension; and a second air tube connecting the second air suspension and the fourth air suspension, wherein each of the first air suspension, the second air suspension, the third air suspension, and the fourth air suspension may include: a housing including a surge chamber; and at least one orifice member detachably coupled to the housing.

According to an embodiments of the present disclosure, the at least one orifice member may be configured to adjust an amount of air entering and exiting the surge chamber of the housing.

According to an embodiments of the present disclosure, at least one from among the first air suspension, the second air suspension, the third air suspension, and the fourth air suspension may include a fastening hole on an upper portion of the housing, to which the at least one orifice member is detachably coupled.

According to an embodiment of the present disclosure, a suspension system may be provided and include: a base; a driving wheel on the base; a plurality of caster units at a front and rear of the driving wheel, wherein each of the plurality of caster units may include: a caster; and an air suspension configured to dampen the caster so as to be liftable by pneumatic pressure; and wherein the air suspension of a first caster unit among the plurality of caster units is connected to the air suspension of a second caster unit among the plurality of caster units by a single flow path.

According to an embodiments of the present disclosure, an inside of the air suspension of the first caster unit and an inside of the air suspension of the second caster unit are communicated through an air tube.

### BRIEF DESCRIPTION OF DRAWINGS

FIG. 1 is a perspective view illustrating a driving robot according to an embodiment of the present disclosure;

FIG. 2 is a block diagram of a driving robot according to an embodiment of the present disclosure;

FIG. 3 is a perspective view illustrating a suspension structure provided for a driving robot according to an embodiment of the present disclosure;

FIG. 4 is a plan view illustrating a suspension structure provided for a driving robot according to an embodiment of the present disclosure;

FIG. 5 is a perspective view illustrating an operation state of a suspension structure when a driving robot goes over a step while traveling according to an embodiment of the present disclosure;

FIG. 6 is a perspective view illustrating a caster unit of a driving robot according to an embodiment of the present disclosure;

FIG. 7 is a cross-sectional view illustrating a caster unit of a driving robot according to an embodiment of the present disclosure;

FIG. 8 is an enlarged view of a portion A shown in FIG. 7, illustrating an orifice member provided in a caster unit of a driving robot according to an embodiment of the present disclosure;

FIG. 9 is a cross-sectional view illustrating a caster unit of a driving robot according to an embodiment;

FIG. 10 is a graph comparing a vibration reduction trend between a driving robot according to an embodiment and a driving robot to which a urethane damper is applied;

FIG. 11 is a cross-sectional view illustrating another example of a linear bush of a caster unit of a driving robot according to an embodiment of the present disclosure;

FIG. 12 is a perspective view illustrating an example in which a plurality of orifice members are applied to a caster unit of a driving robot according to an embodiment of the present disclosure;

FIG. 13 is a perspective view illustrating an example in which an orifice member is coupled to a side of a caster unit of a driving robot according to an embodiment of the present disclosure;

FIG. 14 is a perspective view illustrating an example of including an orifice member that is fastened to a housing of a caster unit of a driving robot according to an embodiment of the present disclosure;

FIG. 15 is a cross-sectional view illustrating the orifice member shown in FIG. 14;

FIG. 16 is a plan view illustrating a suspension structure provided for a driving robot according to an embodiment of the present disclosure;

FIG. 17 is a perspective view illustrating a suspension structure provided for a driving robot according to an embodiment of the present disclosure;

FIG. 18 is a cross-sectional view illustrating an inside of a wheel suspension shown in FIG. 17;

FIG. 19 is a perspective view illustrating an operation state of a suspension structure when a driving robot goes over a step while traveling according to an embodiment of the present disclosure;

FIG. 20 is a plan view illustrating a suspension structure provided for a driving robot according to an embodiment of the present disclosure;

FIG. 21 is a side view illustrating a driving robot according to an embodiment of the present disclosure; and

FIG. 22 is a side view illustrating a driving robot according to an embodiment of the present disclosure.

### DETAILED DESCRIPTION

The embodiments described in this specification and shown in the drawings are merely one or more non-limiting example embodiments of the present disclosure, and there may be various modifications of the example embodiments that are included within the spirit and scope of the present disclosure.

In addition, the same reference numerals or symbols shown in each drawing of the present disclosure indicate parts or components that perform substantially the same function.

Further, the terms used in this specification are used to describe example embodiments, and are not intended to limit the scope of the present disclosure. Singular expressions include plural expressions unless the context clearly dictates otherwise. In this specification, terms such as “comprise,” “include,” and “have” are intended to designate the presence of features, numbers, steps, operations, components, parts, or combinations thereof described in the specification, but are not intended to exclude the possibility of the presence or addition of one or more other features, numbers, steps, operations, components, parts, or combinations thereof.

In addition, terms including ordinal numbers such as “first,” “second,” etc., used in this specification may be used to describe various components, but the components are not limited by the terms, and the above terms are used only for the purpose of distinguishing one component from another. For example, a first component may be referred to as a second component, and similarly, the second component may be referred to as a first component without departing from the scope of the present disclosure. The term “and/or” includes a combination of a plurality of related items described herein or any item of a plurality of related items described herein.

Meanwhile, the terms “front end,” “rear end,” “upper portion,” “lower portion,” “front,” “rear,” “upper end” and “lower end,” “X-axis direction,” “Y-axis direction,” “Z-axis direction,” etc., used in the following description are defined with reference to the drawings, and the shape and location of each component are not limited by these terms.

Hereinafter, a driving robot according to an embodiment will be described with reference to accompanying drawings.

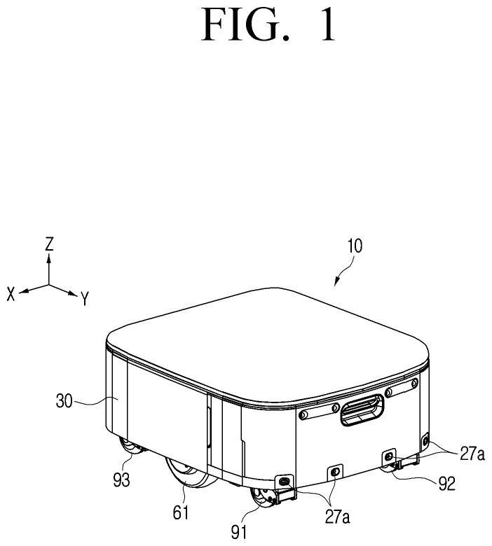

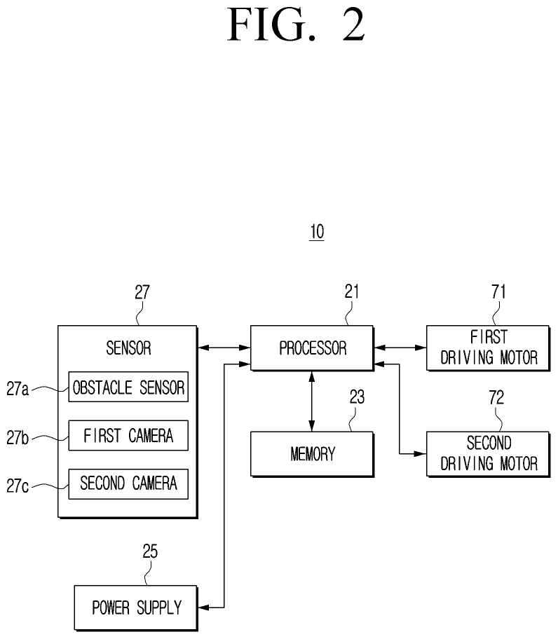

FIG. 1 is a perspective view illustrating a driving robot according to an embodiment of the present disclosure. FIG. 2 is a block diagram of a driving robot according to an embodiment of the present disclosure.

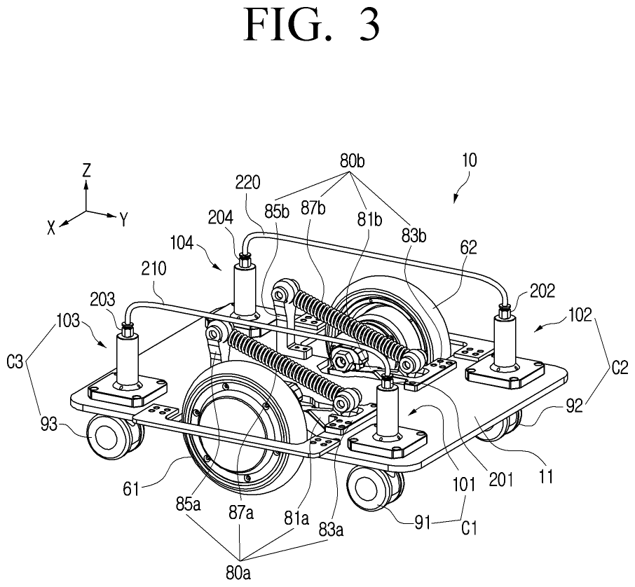

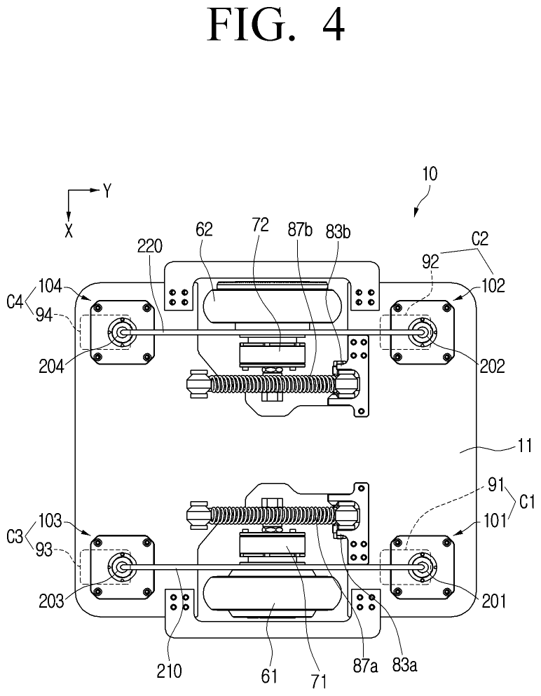

Referring to FIGS. 1 and 2, a driving robot 10 according to an embodiment of the present disclosure may include a processor 21, a memory 23 for storing map information and various information such as driving routes, a power supply 25, at least one sensor 27, a first driving wheel 61 and a second driving wheel 62 (see FIG. 3) for driving, a first driving motor 71 to provide driving force to the first driving wheel 61 and a second driving motor 72 to provide driving force to the second driving wheel 62, respectively, and a first caster 91, a second caster 92, a third caster 93, and a fourth caster 94 (see FIG. 4) to support the driving robot 10 to be able to drive with respect to a running surface.

The processor 21 is configured to control the overall operations of the driving robot 10. The processor 21 may control the first driving motor 71 and the second driving motor 72 to control the driving and stopping operation of the driving robot 10.

The processor 21 may control the first driving motor 71 and the second driving motor 72 to avoid obstacles while traveling based on sensing data received from a plurality of obstacle sensors 27a included in the at least one sensor 27.

The processor 21 may obtain information about a structure of a place where the driving robot 10 is located from a first camera 27b included in the at least one sensor 27. Based on the obtained information about the structure, the processor 21 may divide the space into a plurality of areas, and generate information about a map that includes information about the structure of each of the plurality of areas. The processor 21 may store the information about the generated map in the memory 23. The processor 21 may input a captured image of a second camera 27c included in the at least one sensor 27 into an artificial intelligence model to analyze the captured image. One or more cameras may be used as the second camera 27c. Based on an output value of the artificial intelligence model, the processor 21 may determine the type or posture of a processed object captured by the second camera 27c. The artificial intelligence model may be trained based on captured images of various objects disposed in various postures and their labeling data.

The processor 21 may include one or more processors. The one or more processors may be implemented as a System on Chip (SoC). In this case, in addition to the one or more processors, the SoC may further include memory 23 and a network interface such as a bus for data communication between the processor 21 and the memory 23.

The memory 23 may be configured to store various programs and data for the operation of the driving robot 10. The memory 23 may include a volatile memory or a non-volatile memory. The programs may be stored in the memory 23 as software, and may include, for example, an operating system, middleware, or applications.

The driving robot 10 may be include the first caster 91 and the second caster 92 in front of the first driving wheel 61 and the second driving wheel 62, and the third caster 93 and the fourth caster 94 in the rear of the first driving wheel 61 and the second driving wheel 62. The diameters of the first caster 91, the second caster 92, the third caster 93, and the fourth caster 94 may be smaller than the diameters of the first driving wheel 61 and the second driving wheel 62.

The first caster 91, the second caster 92, the third caster 93, and the fourth caster 94 are not separately powered. The first caster 91, the second caster 92, the third caster 93, and the fourth caster 94 may support the driving robot 10 so that the driving robot 10 can rotate by friction with the running surface while traveling and move along the running surface.

The driving robot 10 according to an embodiment of the present disclosure may include a suspension structure that can prevent or minimize the driving robot 10 from driving unstably by rolling and pitching while traveling on an uneven running surface (e.g., an unpaved surface, a surface having multiple uniform or uneven steps, etc.). Here, the rolling may refer to tilting of the driving robot 10 to the left and right of the driving robot 10 about the Y-axis shown in FIG. 1. The pitching may refer to tilting of the driving robot 10 back and forth of the driving robot 10 about the X-axis shown in FIG. 1.

Hereinafter, a suspension structure of the driving robot 10 according to an embodiment will be described with reference to the accompanying drawings.

FIG. 3 is a perspective view illustrating a suspension structure provided for a driving robot according to an embodiment of the present disclosure. FIG. 4 is a plan view illustrating a suspension structure provided for a driving robot according to an embodiment of the present disclosure.

Referring to FIGS. 3 and 4, the first driving wheel 61 may be connected to a first suspension 80a, and the second driving wheel 62 may be connected to a second suspension 80b.

The first driving wheel 61 may be disposed on the left side of a base 11. The second driving wheel 62 may be disposed on the right side of the base 11. In this case, the first driving wheel 61 and the second driving wheel 62 may be disposed symmetrically about a center axis parallel to the Y-axis of the base 11. The base 11 may be in the shape of a plate having approximately a predetermined thickness.

The first suspension 80a may include a first connecting arm 81a, a first hinge bracket 83a connected to the first connecting arm 81a, a first support 85a, and a first elastic member 87a.

One end of the first connecting arm 81a may be hingedly connected to a portion of the first driving motor 71. For example, one end of the first connecting arm 81a may rotate about an axis parallel to the X-axis. The first driving motor 71 may be provided on one side of the first driving wheel 61. The first driving motor 71 may be controlled by the processor 21 to apply a forward or reverse rotation driving force to the center axis of the first driving wheel 61. The other end of the first connecting arm 81a may be hingedly connected to the first hinge bracket 83a fixed to the base 11. The other end of the first connecting arm 81a may rotate about an axis parallel to the X-axis.

The first support 85a may be fixed to the base 11 so as to be spaced apart from the first hinge bracket 83a by a predetermined interval along the Y-axis direction. The first support 85a may support the first elastic member 87a together with the first connecting arm 81a.

One end of the first elastic member 87a may be connected to the first connecting arm 81a, and the other end of the first elastic member 87a may be connected to the first support 85a. The first elastic member 87a may be, for example, a coil spring. The first elastic member 87a may allow the first driving wheel 61 to move in an up and down direction (Z-axis direction).

The second suspension 80b may be disposed symmetrically to the first suspension 80a. The second suspension 80b may include a second connecting arm 81b, a second hinge bracket 83b connected to the second connecting arm 81b, a second support 85b, and a second elastic member 87b. The second suspension 80b includes substantially the same configuration as the first suspension 80a, and so a repeated description thereof may be omitted.

The first suspension 80a and the second suspension 80b absorb shocks and reduce vibrations applied to the first driving wheel 61 and the second driving wheel 62, respectively, while the driving robot 10 is traveling on the running surface, allowing the driving robot 10 to maintain a stable posture.

The first caster 91, the second caster 92, the third caster 93, and the fourth caster 94 may be connected to a first air suspension 101, a second air suspension 102, a third air suspension 103, and a fourth air suspension 104, respectively. For example, the first caster 91, the second caster 92, the third caster 93, and the fourth caster 94 may be rotatably connected to the first air suspension 101, the second air suspension 102, the third air suspension 103, and the fourth air suspension 104, respectively, about the Z-axis.

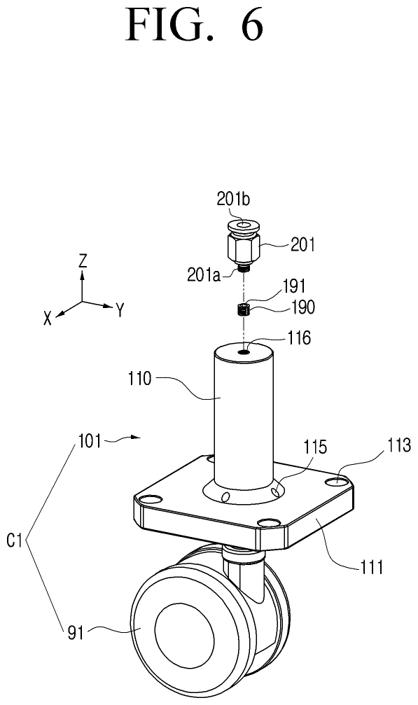

The first caster 91 and the first air suspension 103 may be provided as a single unit (see FIG. 6). In the present disclosure, it is described that a first caster unit C1 may include the first caster 91 and the first air suspension 101. Similarly, a second caster unit C2 may include the second caster 92 and the second air suspension 102. A third caster unit C3 may include the third caster 93 and the third air suspension 103. A fourth caster unit C4 may include the fourth caster 94 and the fourth air suspension 104.

The first air suspension 101, the second air suspension 102, the third air suspension 103, and the fourth air suspension 104 may use air pressure to provide damping to the driving robot 10. In this case, the first air suspension 101, the second air suspension 102, the third air suspension 103, and the fourth air suspension 104 may absorb shocks and reduce vibrations applied to the first caster 91, the second caster 92, the third caster 93, and the fourth caster 94 while the driving robot 10 is traveling. In this case, at least two suspensions are provided with interconnecting flow paths.

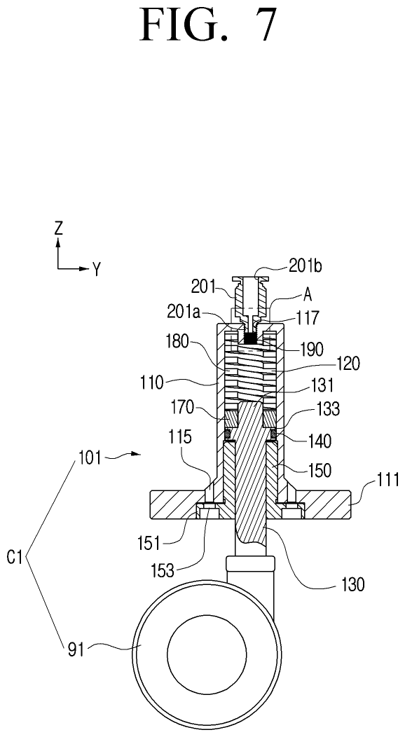

For example, the first air suspension 101 and the third air suspension 103, which may be spaced apart along the Y-axis direction on the left side of the base 11, may be interconnected through a first air tube 210. In this case, a surge chamber 120 (see FIG. 7) provided inside the first air suspension 101 and a surge chamber provided inside the third air suspension 103 may be interconnected through the first air tube 210.

One end of the first air tube 210 may be connected to the first air suspension 101 by a first pneumatic fitting 201, and the other end of the first air tube 210 may be connected to the third air suspension 103 by a third pneumatic fitting 203.

The surge chamber of the first air suspension 101, the first air tube 210, and the surge chamber of the third air suspension 103 may together form a single flow path. Accordingly, the first air suspension 101 and the third air suspension 103 may be influenced by each other by pressure changes that appear in each of the first air suspension 101 and the third air suspension 103.

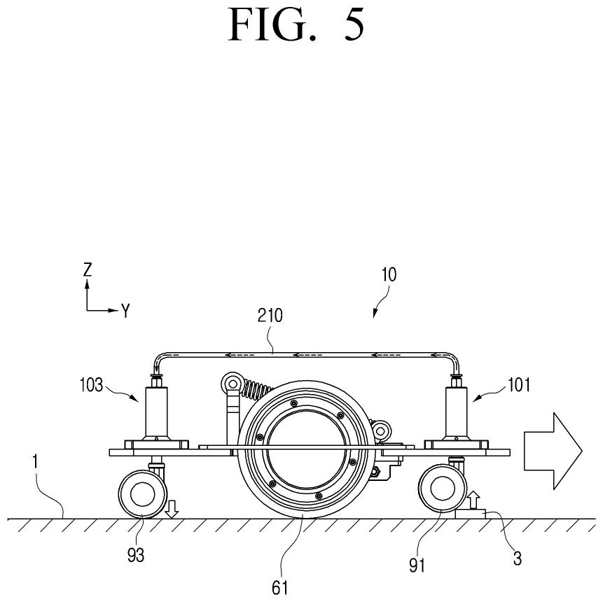

FIG. 5 is a perspective view illustrating an operation state of a suspension structure when a driving robot goes over a step while traveling according to an embodiment of the present disclosure.

Referring to FIG. 5, when the first caster 91 moves upward over a step 3 present on a running surface 1, the pressure in the surge chamber of the first air suspension 101 rises. A certain amount of air is discharged from the surge chamber of the first air suspension 101 and travels through the first air tube 210 to the surge chamber of the third air suspension 103. As the amount of air in the surge chamber of the third air suspension 103 increases, the third caster 93 presses against the running surface 1 and a large repulsive force is exerted against the running surface 1. The repulsive force acting on the third caster 93 has the effect of pushing the rear of the driving robot 10 upward, which is advantageous for the driving robot 10 to overcome the step 3.

The downward motion of the third caster 93 may occur at approximately the same time as the upward motion of the first caster 91. In addition, the downward motion of the first caster 91 may occur at approximately the same time as the upward motion of the third caster 93. Accordingly, the driving robot 10 may prevent or minimize a pitching phenomenon that may appear while going over the step 3 while traveling.

Referring again to FIGS. 3 and 4, the second air suspension 102 and the fourth air suspension 104, which may be disposed spaced apart along the Y-axis direction on the right side of the base 11, may be interconnected through a second air tube 220. One end of the second air tube 220 may be connected to the second air suspension 102 by a second pneumatic fitting 202, and the other end of the second air tube 220 may be connected to the fourth air suspension 104 by a fourth pneumatic fitting 204.

The surge chamber provided inside the second air suspension 102 and the surge chamber provided inside the fourth air suspension 104 may be interconnected through the second air tube 220. The surge chamber of the second air suspension 102, the second air tube 220, and the surge chamber of the fourth air suspension 104 may together form a single flow path.

Accordingly, the second air suspension 102 and the fourth air suspension 104 may be influenced by changes in pressure acting on each of the second air suspension 102 and the fourth air suspension 104. For example, the fourth caster 94 may be lowered by raising the second caster 92, and the second caster 92 may be lowered by raising the fourth caster 94. In this case, the upward motion of the second caster 92 and the downward motion of the fourth caster 94, and the upward motion of the fourth caster 94 and the downward motion of the second caster 92 may be performed almost simultaneously.

Accordingly, since the third caster 93 and the fourth caster 94 may travel while in contact with the running surface 1, the step 3, or uneven surfaces, pitching phenomenon that may appear in the driving robot 10 while traveling may be prevented or minimized.

As described above, the first air suspension 101 and the third air suspension 103 on the left side of the driving robot 10 may be connected by the first air tube 210, and the second air suspension 102 and the fourth air suspension 104 on the right side of the driving robot 10 may be connected by the second air tube 220. In this case, while the driving robot 10 is traveling at a high speed on an uneven running surface with steps or bumps such that the height of the running surface increases or decreases rapidly, the first caster 91, the second caster 92, the third caster 93, and the fourth caster 94 may be in contact with the running surface. Accordingly, not only the pitching phenomenon of the driving robot 10 but also the rolling phenomenon of the driving robot 10 can be prevented or minimized, allowing the driving robot 10 to travel in a stable posture.

According to embodiments of the present disclosure, the driving robot 10 may include, but is not limited to, four casters (e.g., the first caster 91, the second caster 92, the third caster 93, and the fourth caster 94. For example, the driving robot 10 may be provided with three casters on the front portion of the base 11 and three casters on the rear portion of the base 11. The driving robot 10 may be provided with more casters (e.g., eight or more casters) on the base 11 depending on the overall size of the driving robot 10. In this case, the number of casters (hereinafter, referred to as front casters) provided on the front portion of the base 11 may be the same as the number of casters (hereinafter, referred to as rear casters) provided on the rear portion of the base 11.

Further, air suspensions may be added in proportion to the number of casters added to the base 11. For example, when a total of six casters are provided on the base 11 (three front casters and three rear casters), six air suspensions respectively corresponding to the casters may be provided. In this case, the driving robot 10 may be provided with three air tubes, which is ½ of the total number of air suspensions.

Hereinafter, the configuration of the first caster unit C1 will be described in detail with reference to the drawings. The second caster unit C2, the third caster unit C3, and the fourth cast unit C4 have substantially the same configuration as the first caster unit C1, and so repeated descriptions thereof may be omitted.

FIG. 6 is a perspective view illustrating a caster unit of a driving robot according to an embodiment of the present disclosure.

Referring to FIG. 6, the first caster unit C1 may include the first caster 91 and the first air suspension 101. The first caster 91 may be connected to a lower portion of the first air suspension 101 for lifting along the Z-axis direction.

The first air suspension 101 may include a housing 110 with a surge chamber inside, a flange 111 extending from a lower end of the housing 110, and an orifice member 190 detachably coupled to the housing 110.

The housing 110 may be detachably coupled to the base 11 by a plurality of fastening members (e.g., screws) that are coupled to the flange 111. The flange 111 may be provided with a plurality of fastening holes 113.

The upper end of the housing 110 may be provided with a fastening hole 116 into which the orifice member 190 is screwed. A thread portion 201a of the first pneumatic fitting 201 as well as the orifice member 190 may be screwed into the fastening hole 116 of the housing 110. A thread portion 117 (see FIG. 7) is formed on the inner circumferential surface of the fastening hole 116.

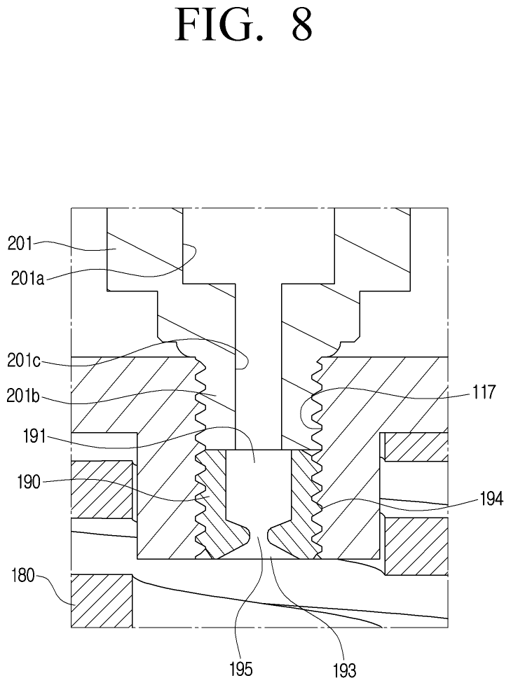

FIG. 7 is a cross-sectional view illustrating a caster unit of a driving robot according to an embodiment of the present disclosure. FIG. 8 is an enlarged view of a portion A shown in FIG. 7, illustrating an orifice member provided in a caster unit of a driving robot according to an embodiment of the present disclosure.

Referring to FIG. 7, a shaft 130 connected to the first caster 91 may be inserted into the inside of the housing 110. The shaft 130 may have an extension part 133 protruding from the outer circumferential surface along the circumferential direction. The extension part 133 may serve as an oil-free bush. The surge chamber 120 filled with air may be provided on the upper side of the extension part 133 inside the housing 110.

A seal ring 140 may be coupled to the extension part 133. The seal ring 140 may prevent or minimize air leakage of the surge chamber 120 provided in the housing 110. In this case, the surge chamber 120 may serve as a cylinder, and the shaft 130 may serve as a piston for stroke movement within the surge chamber 120.

A linear bush 150 surrounding the outer circumferential surface of the shaft 130 may be disposed inside the housing 110. The linear bush 150 may have a flange 151 integrally formed at the lower end thereof. A plurality of fastening holes 153 formed on the flange 151 may correspond to a plurality of fastening holes 115 formed in the housing 110. Accordingly, the flange 151 of the linear bush 150 may be fixed to the housing 110 by a plurality of fastening members. The linear bush 150 may include an outer cylinder, an inner cylinder (retainer) provided inside the outer cylinder, and a plurality of balls disposed in the inner cylinder to support the outer peripheral surface of the shaft 130 through point contact.

The shaft 130 may be slidably supported on the linear bush 150 and move along the Z-axis direction within the housing 110. Accordingly, the first caster 91 may move up and down in the Z-axis direction while the driving robot 10 is traveling.

The extension part 133 of the shaft 130 may interfere with the upper end of the linear bush 150. Accordingly, the shaft 130 can be prevented from leaving the housing 110 by the linear bush 150.

A bearing 170 surrounding an upper end 131 of the shaft 130 may be disposed in the surge chamber 120. The shaft 130 may be rotatably supported on the bearing 170 with reference to the Z-axis.

An elastic member 180 located at an upper side of the bearing 170 may be disposed in the surge chamber 120. The elastic member 180 may be a mold spring or a coil spring. A mold spring is a spring whose line surface is square, and a coil spring is a spring whose line cross section is circular.

One end of the elastic member 180 may be supported on an upper surface inside the housing 110, and the other end of the elastic member 180 may be supported on the extension part 133 of the shaft 130. The elastic member 180 may elastically support the shaft 130 in the Z-axis direction.

The first pneumatic fitting 201 may be provided with a tube insertion hole (e.g., the thread portion 201a) into which one end of the first air tube 210 is airtightly inserted. The tube insertion hole (e.g., the thread portion 201a) and the inside of a thread portion 201b may be communicated. The first pneumatic fitting 201 may be an air movement passage connecting the surge chamber 120 of the first air suspension 101 and the first air tube 210.

Referring to FIG. 8, the orifice member 190 may be screwed into the fastening hole 116 (see FIG. 5) of the housing 110. The orifice member 190 may have a thread portion 194 formed on the outer circumference that may be screwed into the thread portion 117 of the fastening hole 116 of the housing 110. As such, the orifice member 190 may be in the shape of a full threaded bolt.

The orifice member 190 may have a first hole 191 at one end thereof in a shape corresponding to a hexagonal wrench so that it can be screwed into or separated from the fastening hole 116 of the housing 110 using a predetermined tool (e.g., a hexagonal wrench). The orifice member 190 may have a second hole 193 formed at the other end thereof. The first hole 191 and the second hole 193 may be communicated.

The orifice member 190 may be provided with an air passage hole 195 for limiting the amount of air that exits the surge chamber 120 of the housing 110 and enters the surge chamber 120 of the housing 110 through the first air tube 210. The air passage hole 195 may be disposed between the first hole 191 and the second hole 193. The size of the air passage hole 195 may be formed smaller than the size of the first hole 191 and the second hole 193.

The orifice member 190 may have a damping force that is adjustable depending on the size of the air passage hole 195 in accordance with Bernoulli's theorem and mass flow. For example, the damping force may increase as the size of the air passage hole 195 decreases. Therefore, in order to adjust the damping force of the first air suspension 101, the orifice member 190 having the air passage hole 195 of a first size can be separated from the fastening hole 116 of the housing 110, and another orifice member having the air passage hole 195 of a second size different from the first size can be screwed into the fastening hole 116 of the housing 110. As such, the first air suspension 101 according to embodiments of the present disclosure can adjust the damping force through the simple operation of replacing the orifice member 190. The orifice member 190 may change the damping constant by adjusting the amount of inflow and outflow of air according to the size of the air passage hole 195.

When the driving robot 10 is traveling on an uneven running surface, the first air suspension 101 may include an orifice member having a small damping constant to prevent or minimize the rolling and pitching phenomena of the driving robot 10, so that the driving robot 10 can drive in a stable posture. When the driving robot 10 is traveling on a relatively uniform running surface, the orifice member having a large damping constant may be used to absorb vibration quickly.

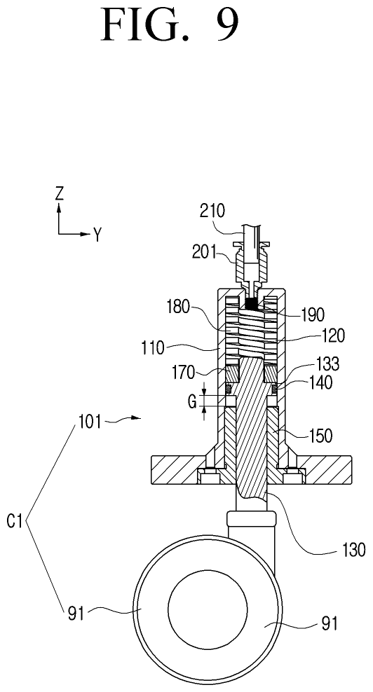

FIG. 9 is a cross-sectional view illustrating a caster unit of a driving robot according to an embodiment of the present disclosure.

Referring to FIG. 9, when the first caster unit C1 is mounted on the base 11 and the driving robot 10 is stabilized on the ground, the shaft 130 of the first air suspension 101 may be inserted into the surge chamber 120 by a predetermined length. Accordingly, a gap G may be formed between the extension 133 of the shaft 130 and the upper end of the linear bush 150.

When the air discharged from the third air suspension 103 through the first air tube 210 is drawn into the surge chamber 120 of the first air suspension 101 by an uneven running surface while the driving robot 10 is traveling, the shaft 130 may descend within a length corresponding to the gap G and touch the running surface.

By adjusting the height of the linear bush 150 or adjusting the elastic coefficient of the elastic member 180, the gap G can be increased or decreased. Accordingly, the overall stroke distance of the shaft 130 can be adjusted.

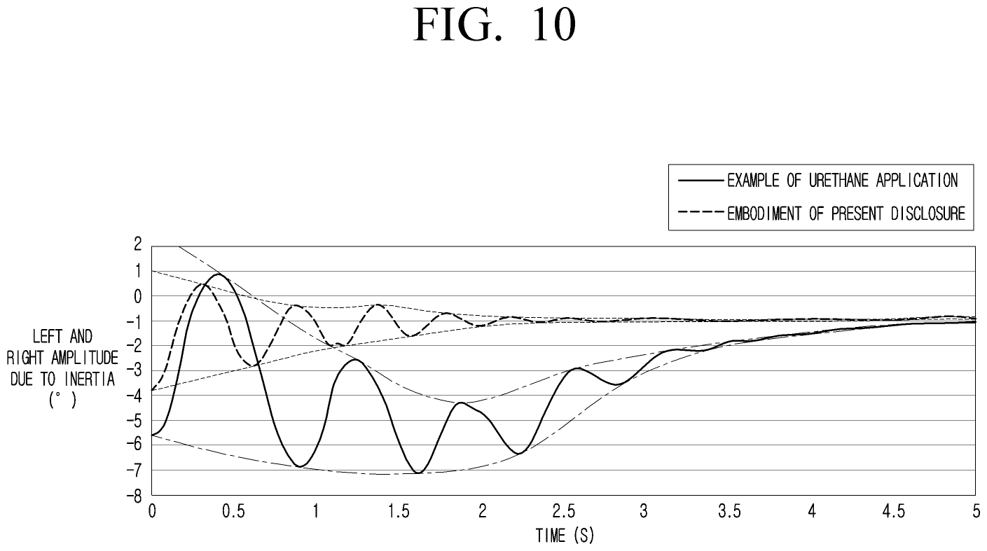

FIG. 10 is a graph comparing a vibration reduction trend between a driving robot according to an embodiment of the present disclosure and a driving robot to which a urethane damper is applied.

The driving robot 10 according to an embodiment of the present disclosure and a driving robot to which a urethane damper is applied are each pushed with a force of 80N (newtons) and shaken left and right. The graph shown in FIG. 10 shows the reduction trend of left and right vibration of each robot through an Inertial Measurement Unit (IMU) sensor.

It appears that in the driving robot 10 according to an embodiment of the present disclosure, from 0 to 2.5 seconds, the left and right variations gradually converge to zero from 5° (−4° to 1°), and after about 2.5 seconds, the left and right vibrations are almost constant. On the other hand, it appears that in the driving robot to which a urethane bumper is applied, from 0 to 5 seconds, the left and right variations gradually converge to zero from 8° (−5.6° to 2° or more), and after about 5 seconds, the left and right vibration decreases.

As such, in the driving robot 10 according to an embodiment, vibration is reduced to converge to zero in about 2.5 seconds, while in the driving robot to which a urethane damper is applied, vibration is reduced in about 5 seconds, which is about twice as long as the driving robot 10 according to an embodiment of the present disclosure. Thus, the driving robot 10 according to an embodiment of the present disclosure can quickly reduce vibration through its suspension structure.

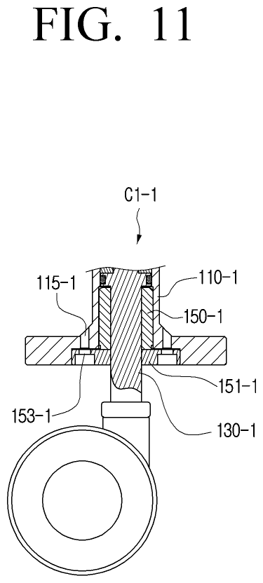

FIG. 11 is a cross-sectional view illustrating another example of a linear bush of a caster unit of a driving robot according to an embodiment of the present disclosure.

A fifth caster unit C1-1 of the driving robot according to an embodiment of the present disclosure may have a configuration which is almost the same as that of the first caster unit C1 described above, and differs in the structure of a linear bush 150-1.

Referring to FIG. 11, the linear bush 150-1 applied to the fifth caster unit C1-1 differs from the linear bush 150 shown in FIG. 7 in that the flange 151 may be omitted. The linear bush 150-1 may have a cylindrical shape and may be disposed in a surge chamber (e.g., see the surge chamber 120 of the housing 110 in FIG. 7) provided inside a housing 110-1. In this case, the linear bush 150-1 may be supported by a cover member 151-1 so as not to be separated from the surge chamber of the housing 110-1.

The cover member 151-1 may be formed with a plurality of fastening holes 153-1 corresponding to a plurality of fastening holes 115-1 formed on the housing 110-1. The cover member 151-1 may be detachably coupled to the housing 110 by a plurality of fastening members. The linear bush 150-1 may slidably support a shaft 130-1 slidably in the Z-axis direction.

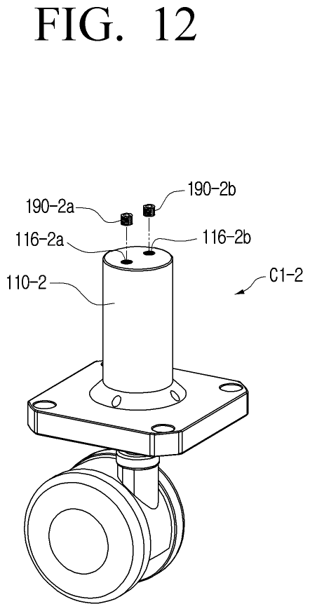

FIG. 12 is a perspective view illustrating an example in which a plurality of orifice members are applied to a caster unit of a driving robot according to an embodiment of the present disclosure.

Referring to FIG. 12, a sixth caster unit C1-2 of the driving robot according to an embodiment of the present disclosure may have a configuration which is almost the same as that of the first caster unit C1 described above. However, the sixth caster unit C1-2 may include a plurality of orifice members.

For example, the sixth caster unit C1-2 may be formed with a first fastening hole 116-2a and a second fastening hole 116-2b which are spaced apart on the upper surface of a housing 110-2. A first orifice member 190-2a may be detachably coupled to the first fastening hole 116-2a, and a second orifice member 190-2b may be detachably coupled to in the second fastening hole 116-2b. The first orifice member 190-2a and the second orifice member 190-2b may have substantially the same structure as the orifice member 190 described above (see FIG. 8).

The first orifice member 190-2a and the second orifice member 190-2b may include air passage holes having different sizes (e.g., diameters) (e.g., see the air passage hole 195 of the orifice member 190 in FIG. 8) from each other. As the first orifice member 190-2a and the second orifice member 190-2b including air passage holes having different sizes are installed in the housing 110-2, the sixth caster unit C1-2 may be set to a desired damping force by adjusting the pressure of a surge chamber (e.g., see the surge chamber 120 of housing 110 in FIG. 7) formed inside the housing 110-2 during damping.

A pneumatic fitting (e.g., see the first pneumatic fitting 201 in FIG. 7) may be fastened to each of the first fastening hole 116-2a and the second fastening hole 116-2b. Each pneumatic fitting may be connected to one air tube (e.g., see the first air tube 210 in FIG. 3).

The sixth caster unit C1-2 has been described as including two orifice members (e.g., the first orifice membe190-2a and the second orifice membe190-2b), but is not limited thereto. For example, the sixth caster unit C1-2 may have three or more orifice members installed. In this case, the fastening holes of the housing 110-2 may be formed in the number corresponding to the number of orifice members.

As such, when a plurality of orifice members are fastened to the sixth caster unit C1-2, the pressure of the surge chamber of the housing 110-2 may be set more precisely in consideration of the environment in which the driving robot 10 is used (the condition of the running surface, the temperature of the place where the driving robot is used, etc.).

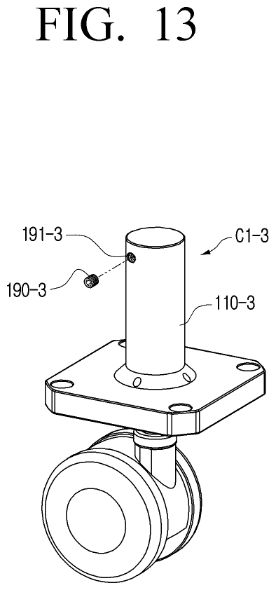

FIG. 13 is a perspective view illustrating an example in which an orifice member is coupled to a side of a caster unit of a driving robot according to an embodiment of the present disclosure.

A seventh caster unit C1-3 of the driving robot according to an embodiment of the present disclosure may have a configuration which is almost the same as that of the first caster unit C1 described above, and differs in the location at which the orifice member is installed.

Referring to FIG. 13, the seventh caster unit C1-3 may have a fastening hole 191-3 formed on the side of the housing 110-3 to which an orifice member 190-3 is detachably fastened. The orifice member 190-3 may have a configuration which is substantially the same as that of the orifice member 190 described above (see FIG. 8).

The seventh caster unit C1-3 has been described as having one orifice member 190-3 fastened to the side of the housing 110-3, but is not limited thereto. For example, the seventh caster unit C1-3 may have two or more orifice members installed on the side of the housing 110-3. In this case, a plurality of fastening holes may be formed on the side of the housing 110-3 to correspond to the number of orifice members. Each of the plurality of fastening holes may be fastened to a pneumatic fitting, respectively (e.g., see the first pneumatic fitting 201 in FIG. 7). Each pneumatic fitting may be connected to one air tube (e.g., see the first air tube 210 in FIG. 3).

The seventh caster unit C1-3 may have at least one orifice member 190-3 fastened to the side of the housing 110-3, and may also have at least one orifice member fastened to the upper surface of the housing 110-3. In this case, the side and upper surface of the housing 110-3 may each include fastening holes corresponding to the number of orifice members. A pneumatic fitting (e.g., see the first pneumatic fitting 201 in FIG. 7) may be fastened to the fastening holes formed on the side and upper surface of the housing 110-3, respectively. Each pneumatic fitting may be connected to one air tube (e.g., see the first air tube 210 in FIG. 3).

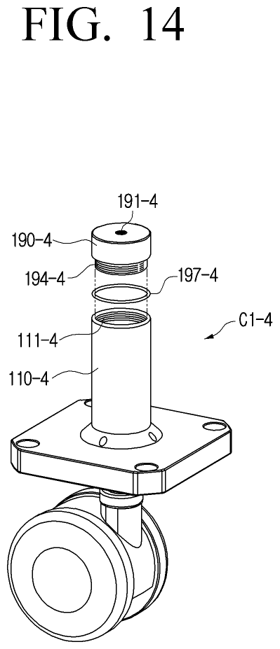

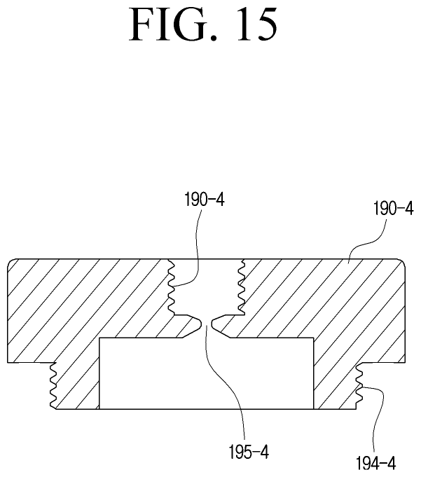

FIG. 14 is a perspective view illustrating an example of including an orifice member that is fastened to a housing of a caster unit of a driving robot according to an embodiment of the present disclosure. FIG. 15 is a cross-sectional view illustrating the orifice member shown in FIG. 14.

A eighth caster unit C1-4 of the driving robot according to an embodiment of the present disclosure may have a configuration which is almost the same as that of the first caster unit C1 described above, and differs in the structure where the orifice member forms part of the housing.

Referring to FIG. 14, the upper portion of a housing 110-4 of an eighth caster unit C1-4 may be open. An orifice member 190-4 may be detachably fastened to the upper portion of the housing 110-4. A thread portion 194-4 that is fastened to a thread portion 111-4 formed on an inner circumferential surface of the housing 110-4 may be formed at a lower portion of the orifice member 190-4. The orifice member 190-4 may include a seal ring 197-4 to prevent or reduce air leakage between the housing 110-4 and the orifice member 190-4 when fastened to the upper portion of the housing 110-4.

Referring to FIG. 15, the orifice member 190-4 may have a larger size than the size of the orifice member 190 (see FIG. 5). For example, the outer diameter of the orifice member 190-4 may be approximately the same as the outer diameter of the housing 110-4.

The orifice member 190-4 may have a fastening hole 191-4 formed on the upper surface thereof through which a pneumatic fitting (e.g., see the first pneumatic fitting 201 in FIG. 7) is detachably fastened. The orifice member 190-4 may have an air passage hole 195-4 having a size (e.g., diameter) smaller than a size of the the fastening hole 191-4. For example, the size of the air passage hole 195-4 of the orifice member 190-4 may be similar to the size of the air passage hole 195 of the orifice member 190 shown in FIG. 8. The orifice member 190-4 may change the damping constant by adjusting the amount of the inflow and the outflow of air according to the size of the air passage holes 195-4.

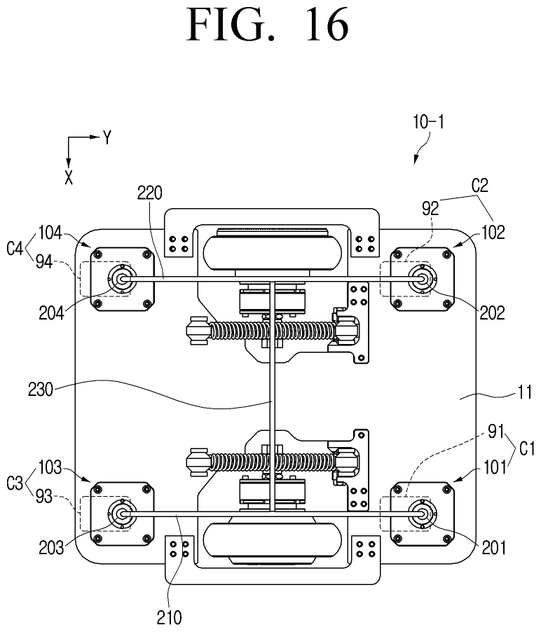

FIG. 16 is a plan view illustrating a suspension structure provided for a driving robot according to an embodiment of the present disclosure.

A driving robot 10-1 according to an embodiment may have a configuration which is almost the same as the driving robot 10 (see FIG. 4), and differs in that the first air tube 210 and the second air tube 220 are connected.

Referring to FIG. 16, the driving robot 10-1 according to an embodiment of the present disclosure may include a third air tube 230 interconnecting the first air tube 210 and the second air tube 220.

The first air suspension 101 and the third air suspension 103 may form a first flow path through the first air tube 210. The second air suspension 102 and the fourth air suspension 104 form a second flow path through the second air tube 220. The driving robot 10-1 may have a single flow path as the first flow path and the second flow path are interconnected by the third air tube 230.

Accordingly, pressure applied to at least one from among the first air suspension 101, the second air suspension 102, the third air suspension 103, and the fourth air suspension 104 may simultaneously affect the remaining air suspensions when the driving robot 10-1 is traveling on the running surface. For example, when the driving robot 10-1 is traveling, if the first caster 91 goes over a step protruding from the ground (e.g., see the step 3 in FIG. 5), the first air suspension 101 may be pressured in an upward direction. In this case, a certain amount of air discharged from the surge chamber of the first air suspension 101 may flow into the second air suspension 102, the third air suspension 103, and the fourth air suspension 104 through a single flow path of the driving robot 10-1.

Accordingly, when the driving robot 10-1 is traveling on the running surface, the first air suspension 101, the second air suspension 102, the third air suspension 103, and the fourth air suspension 104 interact in response to the state of the running surface through a single flow path of the driving robot 10-1, thereby quickly reducing the vibration of the driving robot 10-1.

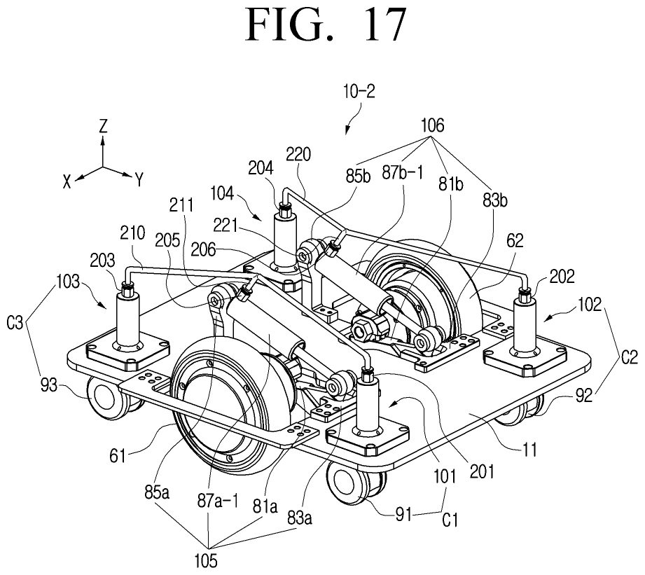

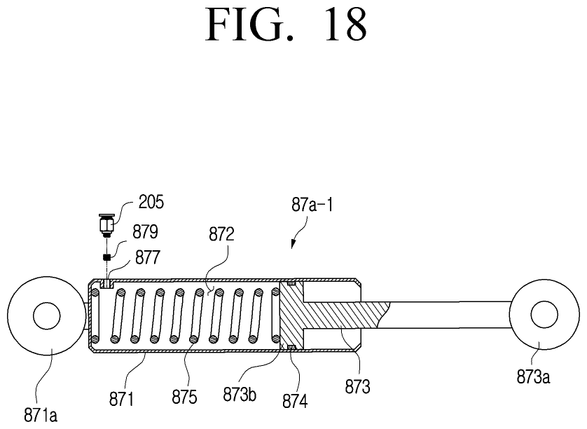

FIG. 17 is a perspective view illustrating a suspension structure provided for a driving robot according to an embodiment of the present disclosure. FIG. 18 is a cross-sectional view illustrating an inside of an air suspension for a driving wheel shown in FIG. 17.

A driving robot 10-2 according to an embodiment may have a configuration which is almost the same as that of the driving robot 10 described above (see FIG. 3). However, the driving robot 10-2 differs in that the driving robot 10-2 includes the fifth air suspension 105 and the sixth air suspension 106 instead of the first suspension 80a and the second suspension 80b of the driving robot 10 described above.

Referring to FIG. 17, the driving robot 10-2 may include the fifth air suspension 105 providing damping to the first driving wheel 61, and the sixth air suspension 106 providing damping to the second driving wheel 62.

The fifth air suspension 105 may be connected through a fifth pneumatic fitting 205 to a first extension tube 211 branched from the first air tube 210. Each of the surge chambers provided inside the first air suspension 101, the third air suspension 103, and the fifth air suspension 105 may be communicated to each other. Accordingly, the first air suspension 101, the third air suspension 103, the fifth air suspension 105, the first air tube 210, and the first extension tube 211 may form a first flow path that is a single flow path. Thus, when the driving robot 10-2 is traveling on the running surface, the pressure applied to at least one from among the first air suspension 101, the third air suspension 103, and the fifth air suspension 105 may simultaneously affect the remaining air suspensions.

The sixth air suspension 106 may be connected through a sixth pneumatic fitting 206 to a second extension tube 221 branched from the second air tube 220. Each of the surge chambers provided inside the second air suspension 102, the fourth air suspension 104, and the sixth air suspension 106 may be communicated to each other. Accordingly, the second air suspension 102, the fourth air suspension 104, the sixth air suspension 106, the second air tube 220, and the second extension tube 221 may form a second flow path that is a single flow path. Thus, when the driving robot 10-2 is traveling on the running surface, the pressure applied to at least one from among the second air suspension 102, the fourth air suspension 104, and the sixth air suspension 106 may simultaneously affect the remaining air suspensions.

The fifth air suspension 105 and the sixth air suspension 106 may have substantially the same construction. Hereinafter, the fifth air suspension 105 will be described, and such description may also be similarly applied to the sixth air suspension 106.

The fifth air suspension 105 may include a first connecting arm 81a connected to the first driving wheel 61, a first hinge bracket 83a connected to the first connecting arm 81a, a first support 85a, and a first damper 87a-1 whose both ends are hingedly connected by the first hinge bracket 83a and the first support 85a. The fifth air suspension 105 may have the same configurations as the first suspension 80a (see FIG. 3) except for a first damper 87a-1 that uses pneumatic pressure. Hereinafter, the first damper 87a-1 will be described with reference to FIG. 18.

Referring to FIG. 18, the first damper 87a-1 may include a cylinder 871, a piston 873 slidably coupled to the cylinder 871, an elastic member 875 disposed inside the cylinder 871 to elastically support the piston 873, and an orifice member 879 detachably fastened to the cylinder 871.

One end of the cylinder 871 may be provided with a first hinge portion 871a hingedly connected to the first support 85a (see FIG. 17). A portion of the piston 873 may be inserted into the cylinder 871 through the other end of the cylinder 871 that is open. The inside of the cylinder 871 may be configured as a surge chamber 872.

A fastening hole 877 communicating with the surge chamber 872 may be formed on one circumferential surface of the cylinder 871. A thread portion may be formed in the fastening hole 877 of the cylinder 871 so that the orifice member 879 can be screwed. The fifth pneumatic fitting 205 may be screwed into the fastening hole 877 of the cylinder 871. The orifice member 879 may have substantially the same structure as the orifice member 190 (see FIG. 8), and so a repeated description thereof may be omitted.

A second hinge portion 873a hingedly connected to the first hinge bracket 83a (see FIG. 17) may be provided on one end of the piston 873. A head 873b that moves along the surge chamber 872 of the cylinder 871 may be provided on the other end of the piston 873.

A seal ring 874 may be coupled to the head 873b of the piston 873. The seal ring 874 may be disposed between the inner circumferential surface of the surge chamber 872 of the cylinder 871 and the outer circumferential surface of the head 873b of the piston 873, and the air present in the surge chamber 872 of the cylinder 871 can prevent or reduce leakage of air from the surge chamber 872 to the open other end of the cylinder 871.

The fifth air suspension 105 may easily adjust the damping force by replacing the orifice member 879 fastened to the first damper 87a-1 with another orifice member having an air passage hole of a different size (e.g., see the air passage hole 195 of the orifice member 190 in FIG. 8).

According to embodiments of the present disclosure, the sixth air suspension 106 may include a sixth damper 87b-1 that has a similar configuration to the first damper 87a-1.

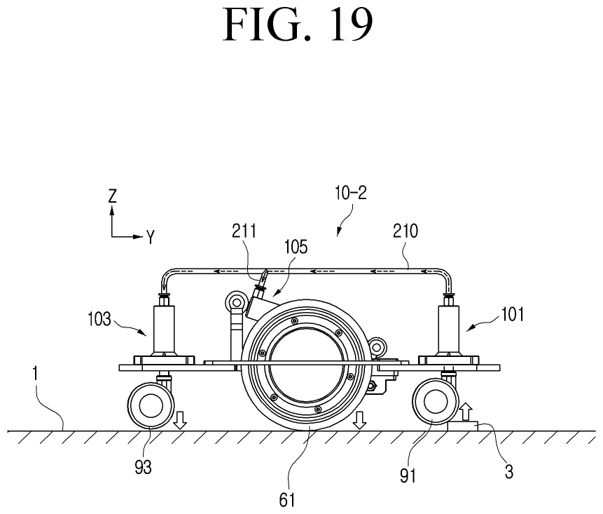

FIG. 19 is a perspective view illustrating an operation state of a suspension structure when a driving robot goes over a step while traveling according to an embodiment of the present disclosure.

Referring to FIG. 19, when the first caster 91 is moved upwardly by the step 3 present on the running surface 1 while the driving robot 10-2 is traveling, the pressure in the surge chamber of the first air suspension 101 rises. A certain amount of air is discharged from the surge chamber of the first air suspension 101 and travels through the first air tube 210 and the second extension tube 221 to the surge chambers of the third air suspension 103 and the fifth air suspension 105. As the amount of air in the surge chamber of the third air suspension 103 and the fifth air suspension 105 increases, the third caster 93 and the first driving wheel 61 press against the running surface 1 and exert a large repulsive force against the running surface 1. The repulsive force acting on the third caster 93 and the first driving wheel 61 has the effect of pushing the rear of the driving robot 10-2 upward, which is advantageous for the driving robot 10-2 to overcome the step 3.

The downward motion of the third caster 93 and the first driving wheel 61 may occur at approximately the same time as the upward motion of the first caster 91. In addition, the downward motion of the first caster 91 may be approximately simultaneous with the upward motion of the third caster 93 and the first driving wheel 61. Accordingly, the driving robot 10 may prevent or minimize a pitching phenomenon that may appear while the driving robot 10 goes over the step 3 during traveling.

The second air suspension 102, the fourth air suspension 104, and the sixth air suspension 106, which are spaced apart and sequentially disposed along the Y-axis direction on the right side of the base 11, may be interconnected through the second air tube 220 and the second extension tube 221. The second air suspension 102, the fourth air suspension 104, and the sixth air suspension 106 may be affected by pressure changes acting on each of them. When the second caster 92 moves in an upward direction by the step 3 present on the running surface while the driving robot 10-2 is traveling, the fourth caster 94 and the second driving wheel 62 may simultaneously descend under the influence of the pressure in the surge chamber of the second air suspension 102.

Accordingly, the driving robot 10-2 may minimize the amount of time that the first caster 91, the second caster 92, the third caster 93, the fourth caster 94, the first driving wheel 61, and the second driving wheel 62 are spaced apart from the running surface 1, the step 3 or bumps, etc., when traveling on the running surface 1. For example, in places where the height of the running surface is rapidly lowered while the driving robot 10-2 is traveling on an uneven running surface with steps or bumps, the first caster 91, the second caster 92, the third caster 93, the fourth caster 94, the first driving wheel 61, and the second driving wheel 62 may contact the running surface at a high speed. Accordingly, a pitching phenomenon appearing in the driving robot 10-2 and/or a rolling phenomenon of the driving robot 10-2 may be prevented or minimized, so that the driving robot 10-2 can drive in a stable posture.

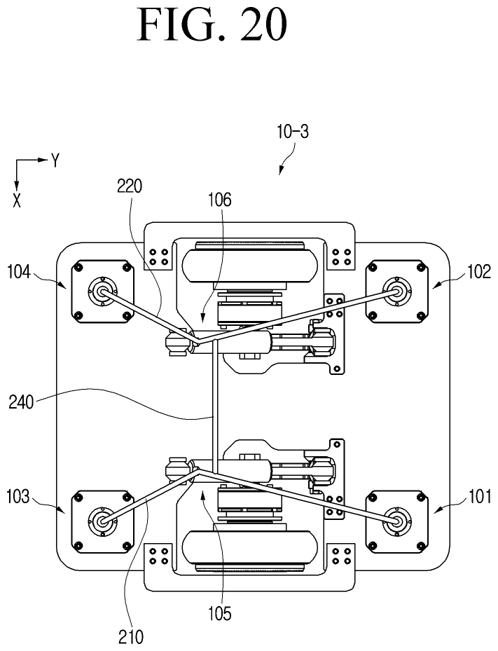

FIG. 20 is a plan view illustrating a suspension structure provided for a driving robot according to an embodiment of the present disclosure.

A driving robot 10-3 according to an embodiment may have a configuration which is almost the same as the driving robot 10-2 described above (see FIG. 17), and differs in that the first air tube 210 and the second air tube 220 are connected.

Referring to FIG. 20, the driving robot 10-3 according to an embodiment of the present disclosure may include a fourth air tube 240 interconnecting the first air tube 210 and the second air tube 220.

The first air suspension 101, the third air suspension 103, and the fifth air suspension 105 may form a first flow path through the first air tube 210 and the second extension tube 221. The second air suspension 102, the fourth air suspension 104, and the sixth air suspension 106 may form a second flow path through the second air tube 220 and the second extension tube 221. The first and second flow paths formed in the driving robot 10-3 may form a single flow path by the fourth air tube 240.

Accordingly, pressure applied to at least one from the first air suspension 101, the second air suspension 102, the third air suspension 103, the fourth air suspension 104, the fifth air suspension 105, and the sixth air suspension 106 when the driving robot 10-3 is traveling on the running surface may simultaneously affect the remaining air suspensions. Thus, when the driving robot 10-3 is traveling on the running surface, the first air suspension 101, the second air suspension 102, the third air suspension 103, the fourth air suspension 104, the fifth air suspension 105, and the sixth air suspension 106 may interact in response to the condition of the running surface through a single flow path of the driving robot 10-3 to quickly reduce the vibration of the driving robot 10-3.

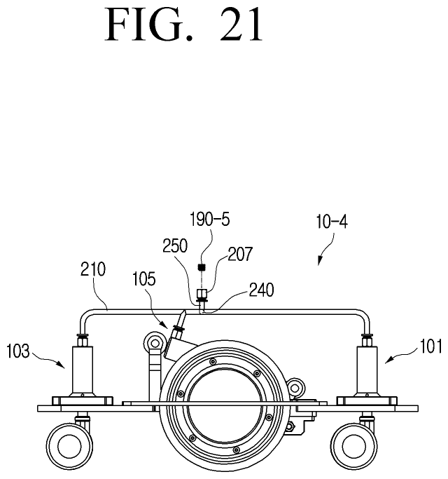

FIG. 21 is a side view illustrating a driving robot according to an embodiment of the present disclosure.

A driving robot 10-4 according to an embodiment of the present disclosure may have a configuration which is almost the same as the driving robot 10-3 described above (see FIG. 17). However, the driving robot 10-4 differs from the driving robot 10-3 in that the orifice members provided in the first air suspension 101, the second air suspension 102, the third air suspension 103, the fourth air suspension 104, the fifth air suspension 105, and the sixth air suspension 106, respectively, are omitted.

Referring to FIG. 21, the driving robot 10-4 according to an embodiment of the present disclosure may include an extension tube 250 branched from the fourth air tube 240, a pneumatic fitting 207 connected to the extension tube 250, and an orifice member 190-5 that may be screwed to the pneumatic fitting 207. The orifice member 190-5 may have a configuration which is almost the same as the orifice member 190 described above (see FIG. 8).

The driving robot 10-4 may have a single flow path like the driving robot 10-3 described above. However, unlike the single flow path of the driving robot 10-3 described above, the single flow path of the driving robot 10-4 may allow outside air to flow in and out through the orifice member 190-5. The driving robot 10-4 may use the one orifice member 190-5 interchangeably to adjust the pressure of the first air suspension 101, the second air suspension 102, the third air suspension 103, the fourth air suspension 104, the fifth air suspension 105, and the sixth air suspension 106.

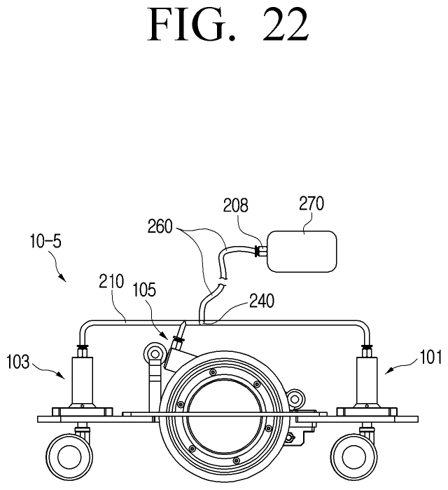

FIG. 22 is a side view illustrating a driving robot according to an embodiment of the present disclosure.

A driving robot 10-5 according to an embodiment may have a configuration which is almost the same as the driving robot 10-3 described above (see FIG. 20), and may further include an air pump 270.

Referring to FIG. 22, the driving robot 10-5 according to an embodiment of the present disclosure may include an extension tube 260 branched from the fourth air tube 240, a pneumatic fitting 208 connected to the extension tube 260, and the air pump 270 connected to the pneumatic fitting 208.

The driving robot 10-5 may actively regulate the pressure of the first air suspension 101, the second air suspension 102, the third air suspension 103, the fourth air suspension 104, the fifth air suspension 105, and the sixth air suspension 106 through the air pump 270 controlled by the processor 21 (see FIG. 2).

For example, when a robotic arm is mounted on the upper portion of the driving robot 10-5, the driving robot 10-5 may need to maintain a posture of the driving robot 10-5 such that when the robotic arm moves, the driving robot 10-5 is firmly supported so that it does not tilt to either side. In this case, the processor 21 may control the air pump 270 to supply air to the first air suspension 101, the second air suspension 102, the third air suspension 103, the fourth air suspension 104, the fifth air suspension 105, and the sixth air suspension 106 to firmly maintain the first air suspension 101, the second air suspension 102, the third air suspension 103, the fourth air suspension 104, the fifth air suspension 105, and the sixth air suspension 106. The first air suspension 101, the second air suspension 102, the third air suspension 103, the fourth air suspension 104, the fifth air suspension 105, and the sixth air suspension 106 may have a lower damper constant as the pressure increases. When the driving robot 10-5 is traveling on an unpaved running surface, the processor 21 may control the air pump 270 to discharge a portion of the air in the first air suspension 101, the second air suspension 102, the third air suspension 103, the fourth air suspension 104, the fifth air suspension 105, and the sixth air suspension 106 to the outside in order to flexibly adjust the first air suspension 101, the second air suspension 102, the third air suspension 103, the fourth air suspension 104, the fifth air suspension 105, and the sixth air suspension 106. Accordingly, the driving robot 10-5 can smoothly travel on an unpaved running surface by preventing or minimizing vibration that occurs during traveling.

Although non-limiting example embodiments of the present disclosure have been described above with reference to the accompanying drawings, embodiments of the present disclosure are not limited to the example embodiments described above, and various modifications may be made by one of ordinary skill in the art without departing from the spirit and scope of the present disclosure, and such modifications are to be understood as a part of the present disclosure.

What is claimed is:

1. A driving robot comprising:
a base;
a first driving wheel on a left side of the base;
a second driving wheel on a right side of the base; and
a plurality of caster units at a front and rear of the first driving wheel and a front and rear of the second driving wheel, respectively,
wherein each of the plurality of caster units comprises:
a caster; and
an air suspension configured to dampen the caster so as to be liftable by pneumatic pressure, and
wherein the air suspension of a first caster unit among the plurality of caster units is connected to the air suspension of a second caster unit among the plurality of caster units by a single flow path.

2. The driving robot of claim 1, wherein an inside of the air suspension of the first caster unit and an inside of the air suspension of the second caster unit are communicated through an air tube.

3. The driving robot of claim 1, wherein the air suspension comprises:
a housing comprising a surge chamber; and
an orifice member configured to adjust an amount of air entering and exiting the surge chamber of the housing.

4. The driving robot of claim 3, wherein the air suspension comprises a fastening hole on an upper portion of the housing, to which the orifice member is detachably coupled.

5. The driving robot of claim 4, wherein the fastening hole of the housing comprises a first thread portion on an inner circumferential surface of the housing; and
wherein the orifice member comprises a second thread portion on an outer circumferential surface of the orifice member, which is screwed to the first thread portion.

6. The driving robot of claim 5, wherein the orifice member is a full threaded bolt.

7. The driving robot of claim 5, wherein the orifice member comprises:
a first hole at a first end of the orifice member;
a second hole at a second end of the orifice member, opposite of the first end of the orifice member, the second hole communicated with the first hole; and
an air passage hole between the first hole and the second hole and smaller than the first hole and the second hole.

8. The driving robot of claim 3, wherein the air suspension comprises:
a shaft, wherein a first end of the shaft is connected to the caster and a second end of the shaft, opposite to the first end of the shaft, is inside the housing;
a linear bush coupled to an inside of the housing and slidably supporting an outer circumference of the shaft; and
an elastic member in the surge chamber of the housing and elastically supporting the shaft along an axial direction of the housing.

9. The driving robot of claim 3, further comprising:
at least one additional orifice member that is screwed to the housing, the at least one additional orifice member configured to adjust the amount of air entering and exiting the surge chamber of the housing.

10. The driving robot of claim 3, wherein the orifice member is screwed to an upper surface of the housing or a side surface of the housing.

11. The driving robot of claim 3, wherein an upper end of the housing is open; and
wherein the orifice member is coupled to the housing, and configured to open and close the upper end of the housing.

12. The driving robot of claim 1, wherein the plurality of caster units comprises:
the first caster unit, wherein the air suspension of the first caster unit is a first air suspension that is in front of the first driving wheel;
the second caster unit, wherein the air suspension of the second caster unit is a second air suspension that is in front of the second driving wheel;
a third caster unit, wherein the air suspension of the third caster unit is a third air suspension that is behind the first driving wheel; and
a fourth caster unit, wherein the air suspension of the fourth caster unit is a fourth air suspension that is behind the second driving wheel,
wherein the first air suspension and the third air suspension are communicated through a first air tube; and
wherein the second air suspension and the fourth air suspension are communicated through a second air tube.

13. The driving robot of claim 12, further comprising:
a third air tube interconnecting the first air tube and the second air tube.

14. The driving robot of claim 13, wherein each of the first air suspension, the second air suspension, the third air suspension, and the fourth air suspension comprises:
a housing comprising a surge chamber; and
a first orifice member configured to adjust an amount of air entering and exiting the surge chamber of the housing.

15. The driving robot of claim 14, further comprising:
a fifth air suspension configured to dampen the first driving wheel, and connected to the first air tube such as to communicate with the first air suspension and the third air suspension; and
a sixth air suspension configured to dampen the second driving wheel, and connected to the second air tube such as to communicate with the second air suspension and the fourth air suspension.

16. A driving robot comprising:
a base;
a first driving wheel on a left side of the base;
a second driving wheel on a right side of the base;
a first caster at a front of the first driving wheel;
a second caster at a front of the second driving wheel;
a third caster at a rear of the first driving wheel;
a fourth caster at a rear of the second driving wheel;
a first air suspension configured to dampen the first caster;
a second air suspension configured to dampen the second caster;
a third air suspension configured to dampen the third caster;
a fourth air suspension configured to dampen the fourth caster;
a first air tube connecting the first air suspension and the third air suspension; and
a second air tube connecting the second air suspension and the fourth air suspension,
wherein each of the first air suspension, the second air suspension, the third air suspension, and the fourth air suspension comprises:
a housing comprising a surge chamber; and
at least one orifice member detachably coupled to the housing.

17. The driving robot of claim 16, wherein the at least one orifice member is configured to adjust an amount of air entering and exiting the surge chamber of the housing.

18. The driving robot of claim 17, wherein at least one from among the first air suspension, the second air suspension, the third air suspension, and the fourth air suspension comprises a fastening hole on an upper portion of the housing, to which the at least one orifice member is detachably coupled.

19. A suspension system comprising:
a base;
a driving wheel on the base;
a plurality of caster units at a front and rear of the driving wheel,
wherein each of the plurality of caster units comprises:
a caster; and
an air suspension configured to dampen the caster so as to be liftable by pneumatic pressure; and
wherein the air suspension of a first caster unit among the plurality of caster units is connected to the air suspension of a second caster unit among the plurality of caster units by a single flow path.

20. The suspension system of claim 19, wherein an inside of the air suspension of the first caster unit and an inside of the air suspension of the second caster unit are communicated through an air tube.
